(19) United States
(12) Patent Application Publication
(10) Pub. No.: US 2014/0160482 A1
(43) Pub. Date: Jun. 12, 2014

(54) OPTICAL SYSTEM FOR ENDOSCOPIC INTERNALLY-REFERENCED INTERFEROMETRIC IMAGING, AND METHOD FOR EMPLOYING THE SAME

(71) Applicants: Guillermo J. Tearney, Cambridge, MA (US); Tzhai Grunzweig, Arlington, MA (US); Kengyeh Ken Chu, Jamaica Plain, MA (US)

(72) Inventors: Guillermo J. Tearney, Cambridge, MA (US); Tzhai Grunzweig, Arlington, MA (US); Kengyeh Ken Chu, Jamaica Plain, MA (US)

(73) Assignee: The General Hospital Corporation, Boston, MA (US)

(21) Appl. No.: 14/100,917

(22) Filed: Dec. 9, 2013

Related U.S. Application Data
(60) Provisional application No. 61/734,675, filed on Dec. 7, 2012.
(60) Provisional application No. 61/791,394, filed on Mar. 15, 2013.

(51) Int. Cl. G01B 9/02; G02B 3/00; G02B 6/32

(52) U.S. Cl. CPC G01B 9/02091; G02B 6/32; G02B 3/0087
USPC 356/451; 385/33; 359/726; 356/497

(57) ABSTRACT

An exemplary arrangement can be provided which can include a lens arrangement which can have at least two reflecting surfaces on opposing sides thereof, each of the reflecting surfaces can have a reflectivity that can be greater than 10%. The lens arrangement can include a gradient index lens, and can have a refractive optical element, a diffractive optical element, a planar convex lens, an aspheric lens, a ball lens or a cylindrical lens.

### CROSS-REFERENCE TO RELATED APPLICATIONS)

This application relates to and claim priority from U.S. Patent Application Ser. No. 61/734,675 filed Dec. 7, 2012 and U.S. Patent Application Ser. No. 61/791,394 filed Mar. 15, 2013, the entire disclosures of which are incorporated herein by reference.

### FIELD OF THE DISCLOSURE

The present disclosure relates to optical imaging, and more particularly to exemplary embodiments of optical system for endoscopic internally-referenced interferometric imaging, and method for employing the same.

### BACKGROUND INFORMATION

Optical coherence tomography (“OCT”) is an imaging modality that provides cellular detail and live motion capture of tissues. It has been employed successfully for microscopic analysis of coronary artery and oesophageal mucosa by the endoscopic approach in living human subjects. OCT is well suited for non-invasive microscopy in cells and tissues since it can be implemented via small, flexible probes, does not require contact with the cell surface or use of contrast medium, and acquires high resolution images with very rapid acquisition times and flexible focal range.

Micro-Optical Coherence Tomography (“μOCT”) is a second-generation imaging technology which facilitates high-resolution ranging in tissue by detecting spectrally resolved interference between the tissue sample (“sample beam”) and a reference (“reference beam”). Recent studies demonstrated μOCT images with an axial resolution of 1.5 μm, transverse resolution of 2 μm and acquisition rate of fifty million pixels per seconds, potentially facilitating in vivo, non-destructive, cellular level imaging of a cubic mm of tissue in, e.g., thirty seconds. Exploring such large region of interest at the cellular level, can facilitate a better understanding and treatment of disease.

Exemplary Challenges In μOCT Probe Design

The unique characteristics of the μOCT modality, including a centrally obscured beam aperture profile (e.g., “donut beam”), require a customized design for the imaging probe. In prior art, a μOCT probe design was demonstrated in which the “donut beam” profile was generated with a right-angle prism coated reflectively with a circular central region remaining uncoated. The fabrication and alignment of such prior design utilizing 2 mm optics would be difficult to further miniaturize to sub-millimeter sizes necessary for human intracoronary use.

Accordingly, there may be a need to overcome at least some of the issues and/or deficiencies described herein above.

### SUMMARY OF EXEMPLARY EMBODIMENTS OF PRESENT DISCLOSURE

To address and/or overcome the above-described problems and/or deficiencies, exemplary embodiments of optical system can be provided for endoscopic internally-referenced interferometric imaging, and method for employing the same.

According to an exemplary embodiment of the present disclosure, e.g., reflective discs are deposited directly onto the optical lens surfaces to form the desired beam profile and act as the reference reflector, resulting in a more compact probe and a simplified assembly process. This exemplary configuration can resemble a Mirau interferometer in general layout, although differs substantially in two ways: the laser beam is split to sample and reference beams by an aperture apodization that may be either partial reflecting of fully reflecting, rather than partial reflectance in the Mirau inteferometer, and the reference arm resides within a focusing optical element.

Exemplary Coronary Artery Application

One exemplary embodiment of a probe design according to the present disclosure can be applicable to microscopic analysis of coronary artery in vivo. For example n optical fiber delivers the broad spectrum laser light to the distal probe, and retrieves the optical signal from the probe to a bedside analysis station, consisting of a spectrometer and image construction and processing system. To physically access the intracoronary environment, the exemplary probe can be miniaturized to a diameter of, e.g., no larger than about 2 mm.

Exemplary Applications Beyond Cardiovascular System

The exemplary embodiment of the probe can also be applicable for organs and tissues outside of the coronary arteries. For example, any organ with an endoscope-accessible lumen, including respiratory airways, gastrointestinal tract, urinary tract, and reproductive tract, can be possible targets for endoscopic μOCT imaging.

Exemplary Interferometric Probe Optical Assembly

One exemplary embodiment of the present disclosure provides an exemplary endoscopic interferometric probe. The exemplary probe can include an optical fiber for delivering illumination and extraction of the interferometer output, collimating and focusing optics, selectively deposited reflective surfaces to apodize the illumination and to act as the reference reflector, an angled mirror to turn the optical axis perpendicularly towards the sideways view, and a rigid enclosure to encase the assembly and isolate the optical components from the biological environment.

Exemplary μOCT Platform With Endoscopic Probe Interface

According to another embodiment of the present disclosure, an integrated imaging system can be provided that can include the exemplary probe described in the previously-described exemplary embodiment and an exemplary platform that can acquire optical reflectance depth profiles, images, volumes, or movies of tissues, or organs, including their secretions and immediate environment, using μOCT technology. In this exemplary embodiment, the endoscopic probe can provide an interface between the exemplary μOCT platform and the imaging target, thus facilitating imaging at the cellular level of tissue accessible to the exemplary endoscope.

These and other objects of the present disclosure can be achieved by provision of an arrangement which can include a lens arrangement which can have at least two reflecting surfaces on opposing sides thereof, each of the reflecting surfaces can have a reflectivity that can be greater than 10%. The lens arrangement can include a gradient index lens, and can have a refractive optical element, a diffraction optical element, a planar convex lens, an aspheric lens, a ball lens or a cylindrical lens.

In certain exemplary embodiments of the present disclosure, at least one of the reflective surfaces can include a metallic coating(s) or a dielectric coating. In some exemplary embodiments of the present disclosure, upon an entry of a first radiation through the lens arrangement, a first portion(s) of the first radiation can impact a first portion of the surfaces to reflect as a second electromagnetic radiation can impact a second one of the surfaces. A second portion(s) of the first radiation can be transmitted as a third electromagnetic radiation via the lens arrangement to reach a sample(s). A spatial electrical field distribution of the second radiation can be different from that of the third radiation along a dimension that can be non-parallel to an optical axis of transmission of the first radiation.

In certain exemplary embodiments of the present disclosure, the focus of the second radiation can be provided at a predetermined optical path length difference from a focus of the third radiation. The predetermined optical path length difference can be less than 10 mm, 3mm 1 mm and/or 100 μm. The spatial electrical field distributions of the second and third radiations can be symmetric along the dimension non-parallel to the optical axis of transmission, and/or rotationally symmetric with respect to the optical axis. A first one of the surfaces can have a first reflectivity profile that can be rotationally symmetric, and a second one of the surfaces can have a second reflectivity profile that can be rotationally symmetric. The first reflectivity profile can be different from the second reflectivity profile along a radius of each of the surfaces.

In certain exemplary embodiments of the present disclosure, a detection apparatus can be configured to detect a fourth radiation provided from the sample(s) that can be associated with the third radiation, and a fifth radiation can be provided from a second one of the surfaces which can be associated with the second radiation, so as to generate a detected signal. A processing apparatus can be configured to determine depth information regarding the sample(s) based on the detected signal.

In certain exemplary embodiments of the present disclosure, the lens arrangement can be situated at least partially in a probe, and the probe can be a catheter or an endoscope. The lens arrangement can be situated at a housing that can have a shape of a pill that can be configured to be swallowed. In certain exemplary embodiments of the present disclosure, an apparatus can be configured to translate or rotate the lens arrangement. In some exemplary embodiments of the present disclosure, an apparatus can be configured to deflect the third and fourth radiations. A wave-guiding arrangement can be provided in an optical path of the lens arrangement, which can include a fiber or a fiber bundle. A source apparatus can provide a radiation to the lens arrangement, and can include a wavelength tunable source(s) or a broadband source. In certain exemplary embodiments of the present disclosure, the detector apparatus can include a spectrometer.

These and other objects, features and advantages of the exemplary embodiments of the present disclosure will become apparent upon reading the following detailed description of the exemplary embodiments of the present disclosure, when taken in conjunction with the appended paragraphs.

### BRIEF DESCRIPTION OF THE DRAWING

Further objects, features and advantages of the present disclosure will become apparent from the following detailed description taken in conjunction with the accompanying drawings showing illustrative embodiments of the present disclosure, in which:

FIG. 1 is a system diagram of an exemplary embodiment of a micron resolution Optical Coherence Tomography (μOCT) endoscopic-probe imaging platform according to the present disclosure;

FIG. 2 is a side cross-sectional view of an exemplary internally referenced interferometric probe;

FIG. 3A is a side cross-sectional view of an input face of an exemplary GRIN fragment as experienced by the light traveling to the sample;

FIG. 3B is a side cross-sectional view of an output face of the GRIN lens as experienced by the light traveling to the sample;

FIG. 3C is a side cross-sectional view of an isomeric image of the exemplary GRIN lens, with deposited mirrors on input and output faces of the GRIN lens;

FIG. 3D is a ray-tracing diagram as being view through the side of the exemplary GRIN lens; and

FIG. 4 is a diagram of a lens configuration composed of diffractive or refractive elements with reflective components to produce an internal interferometric reference.

Throughout the figures, the same reference numerals and characters, unless otherwise stated, are used to denote like features, elements, components or portions of the illustrated embodiments. Moreover, while the subject description will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS

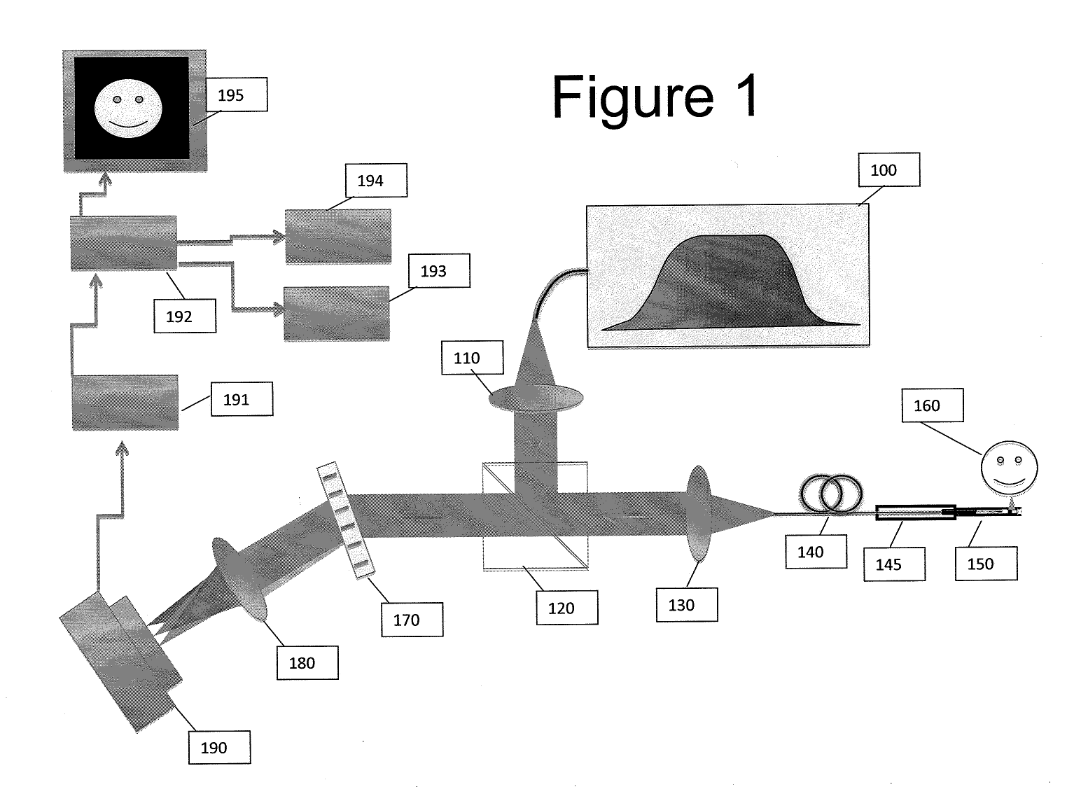

An exemplary embodiment of an integrated μOCT system according to the present disclosure which includes an exemplary imaging platform and endoscopic probe is shown in FIG. 1. For example, as illustrated in FIG. 1, light or another electro-magnetic radiation provided from a broadband source 100 can be collimated by a lens 110. A collimated beam provided from the lens 110 then passes through a beam splitter 120 before it is focused by another lens 130 unto a single-mode fiber-optic patch-cable 140 that transmits the light to a probe 150. Probe 150 is mounted on a translational and/or rotational actuator 145 allowing for precision positioning of the probe tip and for the translation of the position of the probe tip in a desirable fashion during measurement. Probe 150 delivers the light or another electro-magnetic radiation to the target tissue 160. Light reflected from the target tissue 160 is collected by the probe 150 and transmitted back through the single-mode optical fiber 140. The reflected light or another electro-magnetic radiation is then collimated by the lens 130, and then it passes through the beam splitter 120.

Further, the light beam or another electro-magnetic radiation can be separated to its spectral components by a diffraction grating 170, that are then focused by lens 180 onto a detector (e.g., a detection array) 190, thereby creating an A-line of interferometric information. Such information can be transmitted from the detector 190 to an image acquisition device 191 and then to one or more computers 192, where data undergoes processing for display 195 and storage 194. The computer(s) 192 can additionally output analog and/or digital signals 193 to control various parts of the exemplary system, including the light source 100, the detection array 190, and other peripheral devices not shown.

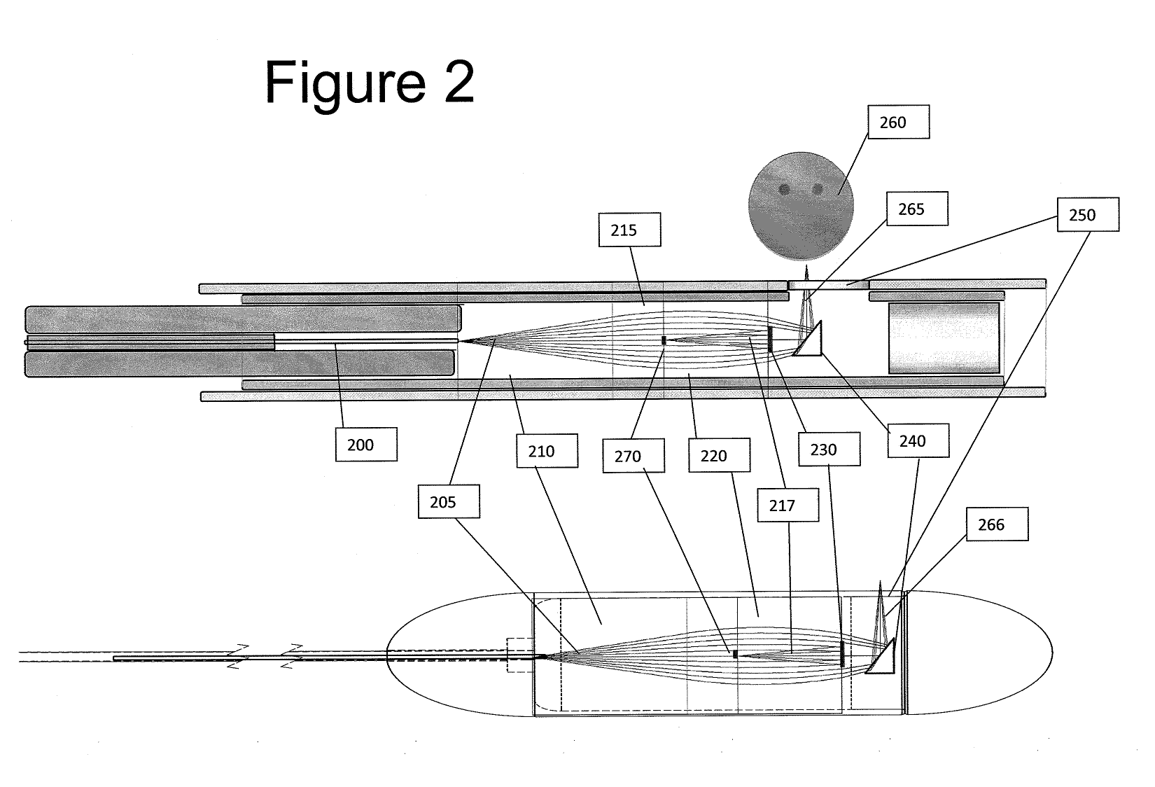

The exemplary probe and the light/radiation path within the exemplary are shown in FIG. 2. In summary, light or another electro-magnetic radiation can be delivered to the probe via an optical fiber, and is shaped and delivered to the sample tissue at the right. The beam can be expanded by the spacer, and focused by two fragments of a gradient-index (GRIN) lens. The second GRIN lens fragment is selectively coated with spatially patterned mirrors on both ends to form a beam splitter and reference reflector. These two mirrors can be either fully reflective or partially reflective coated with a spectrally dependent c. An angled mirror turns the optical axis towards the side to be perpendicular to the axis of the probe.

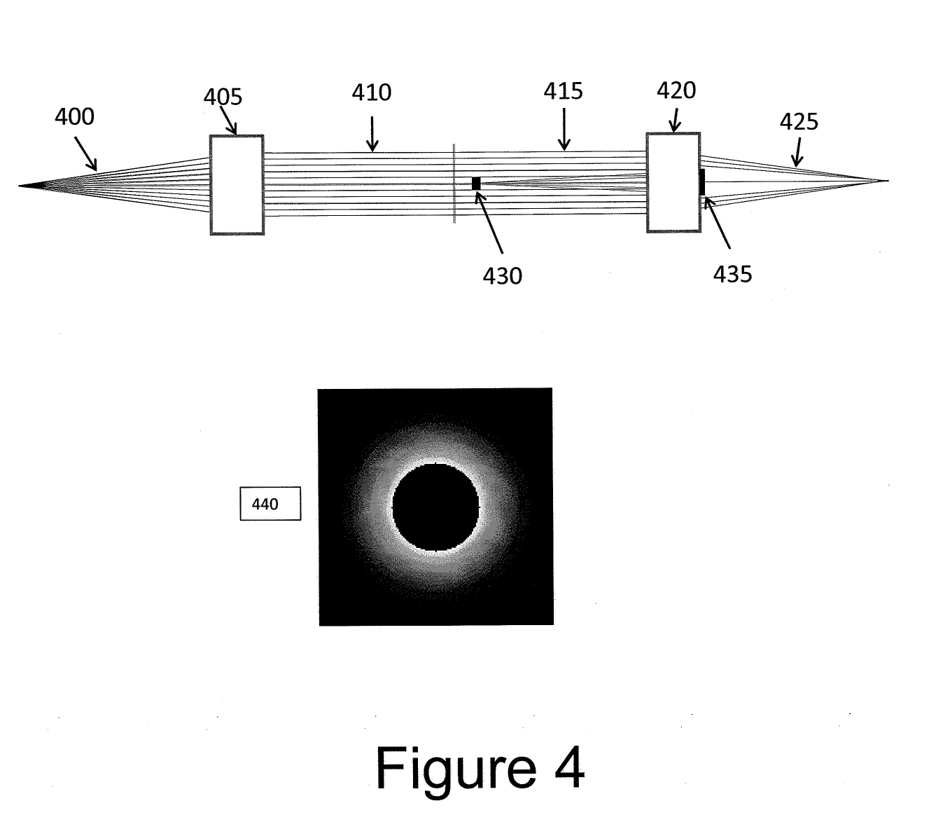

Particularly, in the exemplary probe, the light or other electro-magnetic radiation can emerge from a fiber 200, and propagates as a first radiation 205 through a spacer 210. The first radiation is partially focused by a first GRIN lens 215, and then further focused by a second GRIN lens 220. An output face of the second GRIN lens 220 can be at least partially covered by an apodizing reflector 230. A beam diameter at this point can be larger than the diameter of the apodizing reflector 230. A center part of the beam, designated the second radiation 217, can be reflected back into the second GRIN lens 220, while the light/radiation not redirected by the mirror 230 forms a third radiation 265, which may be of annular shape as illustrated in FIG. 4. The third radiation is reflected by a 45-degree mirror 240, and can be focused through a window 250 to the sample 260. The light/radiation backscattered by the sample 260 can be incident on the second GRIN lens 220, and can be recombined with light reflected from a reference mirror 270, which can reach the apodizing reflector 230 at a second time. This returning light/radiation can contain an interference pattern, e.g., representing the reflectance of the sample 260 as a function of depth. The combined returning light/radiation can be focused by the second GRIN lens 220 and the first GRIN lens 215 back to the fiber 200.

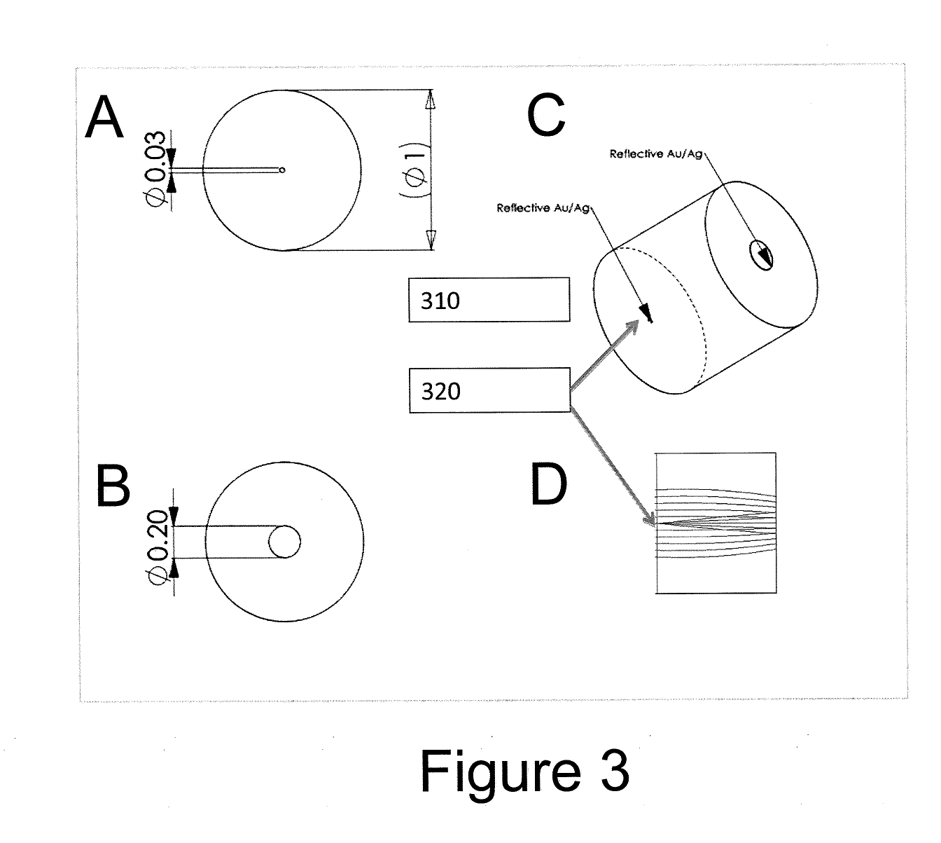

FIGS. 3A-3D illustrate exemplary diagrams of an exemplary GRIN lens fragment with deposited circular reflectors on each end face, according to exemplary embodiments of the present disclosure. In particular, FIG. 3A shows a cross-sectional diagram of an input face of the GRIN lens. For example, FIG. 3A illustrates the exemplary GRIN lens with the circular small reference reflector 320 deposited in a center of the face, e.g., concentric with the optical axis. FIG. 3B shows a cross-sectional diagram of an output face of the exemplary GRIN lens, and in its center, the circular larger apodizing reflector 320 can be provided concentric with the optical axis. FIG. 3C illustrates an isometric view of the exemplary GRIN lens providing both reflectors 310 and 320. FIG. 3D shows a ray-tracing diagram of a two-dimensional cross section from the side of the exemplary GRIN lens. For example, a beam can enter from the input face on the left and travels through the GRIN lens. On the output face, the beam can be spatially split by the apodizing reflector 310. The beams central part can be reflected back, while its rim would not be reflected, thus forming an annulus. The central part of the beam, having been reflected by the apodizing reflector 310, can travel back to the input face of the GRIN lens, and can then be focused there onto the reference reflector 320.

FIG. 4 illustrates an exemplary diagram of a general lens arrangement with apodizing reflectors as in FIG. 3, but where the focusing elements can be diffractive or refractive lenses or any combination thereof. A first radiation 400 enters the lens arrangement and is partially focused or collimated by focusing optic 405, which is composed of at least one diffractive or refractive element. The partially focused or collimated output radiation 410 continues to focusing optic 420. A reflecting surface 435 present near the exit surface of 420 divides the radiation along two paths. One portion of the first radiation is reflected as a second radiation in a manner such that the second radiation traverses the focusing optic 420 in the reverse direction of the first radiation. A reflecting element 430 is placed near the focus of the second radiation, such that a larger portion of the second radiation energy is reflected than that of the first radiation. The portion of the first radiation that is not reflected by element 435 continues forward as a third radiation 425 towards the sample. 440 illustrates an exemplary intensity profile of the third radiation.

The foregoing merely illustrates the principles of the disclosure. Various modifications and alterations to the described embodiments will be apparent to those skilled in the art in view of the teachings herein. Indeed, the arrangements, systems and methods according to the exemplary embodiments of the present disclosure can be used with and/or implement any OCT system, OFDI system, SD-OCT system or other imaging systems, and for example with those described in International Patent Application PCT/US2004/029148, filed Sep. 8, 2004 which published as International Patent Publication No. WO 2005/047813 on May 26, 2005, U.S. patent application Ser. No. 11/266,779, filed Nov. 2, 2005 which published as U.S. Patent Publication No. 2006/0093276 on May 4, 2006, and U.S. patent application Ser. No. 10/501,276, filed Jul. 9, 2004 which published as U.S. Patent Publication No. 2005/0018201 on Jan. 27, 2005, and U.S. Patent Publication No. 2002/0122246, published on May 9, 2002, the disclosures of which are incorporated by reference herein in their entireties. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly being incorporated herein in its entirety. All publications referenced above can be incorporated herein by reference in their entireties.

What is claimed is:

1. An arrangement, comprising:
a lens arrangement which has at least two reflecting surfaces on opposing sides thereof, wherein a reflectivity of each of the reflecting surfaces is greater than 10%.

2. The arrangement according to claim 1, wherein the lens arrangement comprises a gradient index lens.

3. The arrangement according to claim 1, wherein the lens arrangement comprises at least one of a refractive optical element, a diffraction optical element, a planar convex lens, an aspheric lens, a ball lens or a cylindrical lens.

4. The arrangement according to claim 1, wherein at least one of the reflective surfaces comprises at least one of a metallic coating or a dielectric coating.

5. The arrangement according to claim 1, wherein, upon an entry of a first radiation through the lens arrangement, at least one first portion of the first radiation impacts a first portion of the surfaces to reflect as a second electromagnetic radiation impacts a second one of the surfaces, wherein at least one second portion of the first radiation is transmitted as a third electromagnetic radiation via the lens arrangement to reach at least one sample, and wherein a spatial electrical field distribution of the second radiation is different from that of the third radiation along a dimension that is non-parallel to an optical axis of transmission of the first radiation.

6. The arrangement according to claim 5, wherein a focus of the second radiation is provided at a predetermined optical path length difference from a focus of the third radiation.

7. The arrangement according to claim 6, wherein the predetermined optical path length difference is less than 10 mm.

8. The arrangement according to claim 6, wherein the predetermined optical path length difference is less than 3 mm.

9. The arrangement according to claim 6, wherein the predetermined optical path length difference is less than 1 mm.

10. The arrangement according to claim 6, wherein the predetermined optical path length difference is greater than 100 μm.

11. The arrangement according to claim 5, wherein the spatial electrical field distributions of the second and third radiations are symmetric along the dimension non-parallel to the optical axis of transmission.

12. The arrangement according to claim 5, wherein the spatial electrical field distributions of at least one the second radiation or the third radiation is rotationally symmetric with respect to the optical axis of transmission.

13. The arrangement according to claim 1, wherein a first one of the surfaces has a first reflectivity profile that is rotationally symmetric, and a second one of the surface has a second reflectivity profile that is rotationally symmetric, and wherein the first reflectivity profile is different from the second reflectivity profile along a radius of each of the surfaces.

14. The arrangement according to claim 5, further comprising a detection apparatus which is configured to detect a fourth radiation provided from the at least one sample that is associated with the third radiation, and a fifth radiation provided from a second one of the surfaces which is associated with the second radiation, so as to generate a detected signal.

15. The arrangement according to claim 14, further comprising a processing apparatus which is configured to determine depth information regarding the at least one sample based on the detected signal.

16. The arrangement according to claim 1, wherein the lens arrangement is situated at least partially in a probe.

17. The arrangement according to claim 16, wherein the probe is at least one of a catheter or an endoscope.

18. The arrangement according to claim 1, wherein the lens arrangement is situated at a housing that has a shape of a pill that is configured to be swallowed.

19. The arrangement according to claim 1, further comprising an apparatus which is configured to translate or rotate the lens arrangement.

20. The arrangement according to claim 14, further comprising an apparatus which is configured to deflect the third and fourth radiations.

21. The arrangement according to claim 14, wherein the detector apparatus includes a spectrometer.

22. The arrangement according to claim 1, further comprising a wave-guiding arrangement which is provided in an optical path of the lens arrangement.

23. The arrangement according to claim 22, wherein the wave-guiding arrangement includes at least one of a fiber or a fiber bundle.

24. The arrangement according to claim 1, further comprising a source apparatus which provides a radiation to the lens arrangement, and includes at least one of a wavelength tunable source or a broadband source.

25. A method, comprising:
providing a lens arrangement which has at least two reflecting surfaces on opposing sides thereof, wherein a reflectivity of each of the reflecting surfaces is greater than 10%.
